(19) United States
(12) Patent Application Publication
(10) Pub. No.: US 2015/0161926 A1
(43) Pub. Date: Jun. 11, 2015

(54) LASER PROJECTION/DISPLAY APPARATUS

(71) Applicant: Hitachi-LG Data Storage, Inc., Tokyo (JP)

(72) Inventors: Yuya OGI, Tokyo (JP); Fumio HARUNA, Tokyo (JP); Yoshiho SEO, Tokyo (JP); Satoshi OUCHI, Tokyo (JP)

(21) Appl. No.: 14/559,425

(22) Filed: Dec. 3, 2014

(30) Foreign Application Priority Data
Dec. 5, 2013 (JP) 2013-251926

(51) Int. Cl. G09G 3/02; G09G 3/34; H04N 9/31

(52) U.S. Cl. CPC G09G 3/025; H04N 9/3129; G09G 3/3413; G09G 2320/0626; G09G 2320/08; G09G 2360/144; G09G 2360/145; G09G 2310/024

(57) ABSTRACT

A laser projection/display apparatus includes a photosensor for detecting light amounts of laser lights, and an image processing unit that processes an image signal based on the detected light amounts, and supplies the image signal to a laser light source drive unit. The image processing unit obtains data for making the light amounts of the laser lights, which are detected by the photosensor, equal to respective values at a second luminance that is different from a first luminance, which is the luminance of the image currently being displayed, during a flyback period of the image signal. The image processing unit processes an image signal to be supplied to the laser light source drive unit based on the data when the image signal is projected and displayed with the second luminance.

### CROSS-REFERENCE TO RELATED APPLICATION

This application claims the Japanese Patent Application No. 2013-251926 file Dec. 5, 2013, which is incorporated herein by reference in its entirety.

### BACKGROUND

The present invention relates to a laser projection/display apparatus in which lights from a light source such as semiconductor laser lights are scanned by a two-dimensional scanning mirror such as a MEMS (Micro Electro Mechanical Systems) mirror, and an image is displayed.

In recent years, a small-sized projector including a MEMS and semiconductor laser light sources has been widely used. For example, Japanese Unexamined Patent Application Publication No. 2006-343397 and Japanese Unexamined Patent Application Publication No. Hei5 (1993)-224166 disclose a projector that projects the image of an object by performing scanning horizontally and vertically using a biaxial MEMS mirror or a biaxial scanner, and at the same time, by modulating laser lights emitted from the semiconductor laser light source. It is known that such a small-sized projector using semiconductor laser components as above has a problem in that the white balance of a display image changes since the light amount versus forward current characteristic of a semiconductor laser component changes with temperature.

Japanese Unexamined Patent Application Publication No. Hei5 (1993)-224166 discloses a gradation correction apparatus that light-modulates a light modulation device by inserting a test signal during a flyback period, that is, a non-image display period, makes a memory device memorize an actual gradation characteristic and an ideal characteristic both of which are calculated by a microprocessor, and automatically performs a gradation correction while the small-sized projector is being kept in normal operation.

### SUMMARY

In Japanese Unexamined Patent Application Publication No. Hei5 (1993)-224166, however, a light adjustment operation, in which the brightness, that is, the light intensity of a projected image is changed, is not taken into consideration. In other words, plural light intensities cannot be properly dealt with in the light adjustment operation since a gradation correction to deal with the plural light intensities is not taken into consideration. In addition, a method, in which a gradation correction is performed while a current control range during a display period and a current control range during a flyback period are set to be different from each other, is not described in Japanese Unexamined Patent Application Publication No. Hei5 (1993)-224166. On the other hand, the above method will be disclosed in the following embodiments of the present invention.

The present invention is achieved with the abovementioned problem in mind, and a main object of the present invention is to provide a laser projection/display apparatus which has a little change in the white balance of a displayed image owing to the variation in temperature or the like while keeping the number of displayed gradations constant during the light adjustment operation.

In order to solve the abovementioned problem, the present invention provides a laser projection/display apparatus for displaying an image corresponding to an image signal by projecting laser lights of a plurality of colors corresponding to the image signal. The laser projection/display apparatus includes: a laser light source that emits the laser lights of the colors; a laser light source drive unit that drives the laser light source so that the laser light source emits laser lights corresponding to the image signal; a scanning unit that scans the laser lights emitted by the laser light source in accordance with a sync signal related to the image signal; an image processing unit that processes the image signal in accordance with the light amounts of the laser lights detected by the photosensor, and supplies the processed image signal to the laser light source drive unit. In addition, the image processing unit obtains data used for making the light amounts of the laser lights, which are detected by the photosensor, equal to respective predefined values regarding plural luminance levels during the flyback period of the image signal, and the image processing unit processes the image signal to be supplied to the laser light source drive unit on the basis of the data when the image signal is projected and displayed.

Further, in the laser projection/display apparatus, the image processing unit obtains data used for making the light amounts of the laser lights, which are detected by the photosensor, equal to respective predefined values regarding plural luminance levels at a second luminance that is different from a first luminance, which is the luminance of the image currently being displayed, during the flyback period of the image signal, and the image processing unit processes an image signal to be supplied to the laser light source drive unit on the basis of the data when the image signal is projected and displayed with the second luminance.

According to the present invention, there is an advantage in that a laser projection/display apparatus having a little change in the white balance of a displayed image owing to the variation in temperature while keeping the number of displayed gradations constant during the light adjustment operation can be provided.

### BRIEF DESCRIPTION OF THE DRAWINGS

FIG. 1 is a block diagram showing the basic configuration of a laser projection/display apparatus according to a first embodiment;

FIG. 2 is a block diagram showing a signal processing unit according to the first embodiment;

FIG. 3 is a characteristic diagram showing an example of light amount versus forward current characteristic of a semiconductor laser component;

FIG. 4A is a first characteristic diagram for explaining the operation of an LUT according to the first embodiment;

FIG. 4B is a second characteristic diagram for explaining the operation of the LUT according to the first embodiment;

FIG. 5 is a block diagram showing an image correction unit according to the first embodiment;

FIG. 6 is a characteristic diagram for explaining the operation of the LUT in the case where a current control range is not changed;

FIG. 7 is a flowchart showing the entire processing of the first embodiment;

FIG. 8 is a timing chart showing the entire processing of the first embodiment;

FIG. 9 is a flowchart showing the entire processing of a second embodiment;

FIG. 10 is a timing chart showing the entire processing of the second embodiment;

FIG. 11 is a timing chart showing the entire processing of another configuration according to the second embodiment;

FIG. 12 is a flowchart showing the entire processing of a third embodiment;

FIG. 13 is a characteristic diagram showing an example of light amount versus forward current characteristic of a semiconductor laser component; and

FIG. 14 is a timing chart showing the entire processing of a fourth embodiment.

### DETAILED DESCRIPTION

Hereinafter, several embodiments of the present invention will be described in detail with reference to the accompanying drawings. Here, the following descriptions will be made only for explaining these embodiments of the present invention, and there is no intention to limit the scope of the present invention to these embodiments. Therefore, it is possible for a person skilled in the art to employ alternative embodiments in which each component or all the components of the above embodiments can be replaced with an equivalent component or equivalent components respectively, so that it is to be understood that such alternative embodiments naturally fall within the scope of the present invention.

### First Embodiment

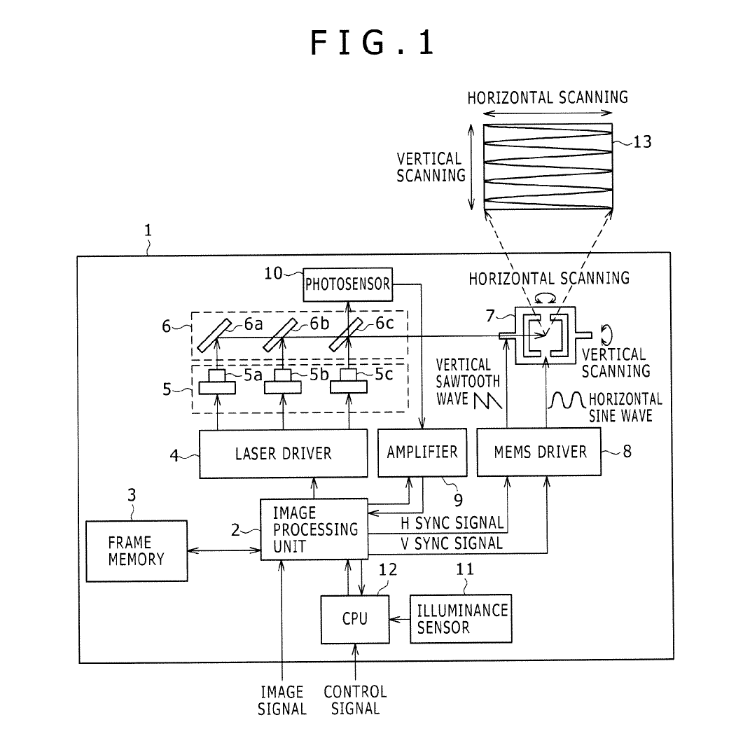

Hereinafter, a first embodiment of the present invention will be described in detail with reference to the accompanying drawings. First, the entire configuration of a laser projection/display apparatus according to the present invention, and the output characteristic of a semiconductor laser component will be explained with reference to FIG. 1 to FIG. 3.

FIG. 1 is a block diagram showing the basic configuration of the laser projection/display apparatus according to this embodiment. The laser projection/display apparatus 1 includes an image processing unit 2, a frame memory 3, a laser driver 4, a laser light source 5, a reflecting mirror 6, a MEMS scanning mirror 7, a MEMS driver 8, an amplifier 9, a photosensor 10, an illuminance sensor 11, and a CPU (Central Processing Unit) 12, and displays a displayed image 13.

The image processing unit 2 creates an image signal by performing some corrections on an image signal input from outside, and further creates a horizontal sync signal and a vertical sync signal each of which is synchronized with the created image signal. Subsequently, the image processing unit 2 supplies these three signals to the MEMS driver 8. In addition, the image processing unit 2 controls the laser driver 4 (also referred to as the laser light source drive unit) in accordance with information obtained from the CPU 12, and makes a laser output adjustment for keeping the white balance constant. The above operation of the image processing unit 2 will be described in detail later.

Here, the abovementioned corrections includes an image distortion correction owing to the scanning performed by the MEMS scanning mirror 7, an image gradation adjustment using a look-up table (described as a LUT hereinafter) and the like. Here, the image distortion is generated owing to the fact that the relative angle between the laser projection/display apparatus 1 and the projection plane is different, and owing to the deviance between the optical axis of the laser light source 5 and that of the MEMS scanning mirror 7, and the like. The matters regarding the LUT will be described later.

The laser driver 4 receives an image signal output from the image processing unit 2, and modulates laser lights from the laser light source 5 in accordance with the received image signal. The laser light source 5 includes, for example, three semiconductor laser components (5a, 5b, and 5c) for RGB, and emits RBG laser lights which respectively correspond to RGB of the image signal.

A light is synthesized using three RGB laser lights by the reflecting mirror 6 including three mirrors, and the synthesized light is irradiated to the MEMS scanning mirror 7. A special optical element that reflects a light with a specific wavelength and passes lights with other wavelengths is used in the reflecting mirror 6. This optical element is commonly referred to as a dichroic mirror.

For details, the reflecting mirror 6 includes a dichroic mirror 6a that reflects a laser light emitted from the semiconductor laser component 5a (for example, R light) and passes laser lights of other colors, a dichroic mirror 6b that reflects a laser light emitted from the semiconductor laser component 5b (for example, G light) and passes laser lights of other colors, and a dichroic mirror 6c that reflects a laser light emitted from the semiconductor laser component 5c (for example, B light) and passes laser lights of other colors, synthesizes a light using the R, G, and B laser lights, and supplies the synthesized light to the MEMS scanning mirror 7.

The MEMS scanning mirror 7 is an image scanning unit including a biaxial rotation mechanism, and is capable of vibrating the middle mirror section thereof in two directions, that is, in the horizontal direction and vertical direction. The vibration control of the MEMS scanning mirror 7 is performed by the MEMS driver 8. The MEMS driver 8 creates a sine-wave in synchronization with a horizontal sync signal output from the image processing unit 2, and creates a sawtooth wave in synchronization with a vertical sync signal as well. The MEMS driver 8 drives the MEMS scanning mirror 7 using the above sine-wave and sawtooth wave.

After receiving a sine-wave signal from the MEMS driver 8, the MEMS scanning mirror 7 carries on a sine-wave resonant motion in the horizontal direction. At the same time, the MEMS scanning mirror 7 carries on a uniform motion in the vertical direction after receiving a sawtooth signal from the MEMS driver 8. As a result, the laser lights are scanned as shown in the displayed image 13, and the scanning is synchronized with the modulation operation performed by the laser driver 4, therefore an input image is optically projected.

The photosensor 10 measures the light amounts of projected lights, and outputs the measured results to the amplifier 9. The amplifier 9 amplifies the outputs of the photosensor 10 in accordance with a gain set by the image processing unit 2, and outputs the amplified outputs to the image processing unit 2. FIG. 1 shows that the photosensor 10 is disposed so as to detect leakage lights of RGB laser lights used for synthesis carried on by the reflecting mirror 6. In other words, the photosensor 10 is disposed opposite to the semiconductor laser component 5c with the reflecting mirror 6c therebetween. Although the reflecting mirror 6c has a characteristic that passes the laser lights from the semiconductor laser components 5a and 5b, and reflects the laser light from the semiconductor laser component 5c, since the characteristic of the reflecting mirror 6c cannot achieve 100 percent passage and 100 percent reflection respectively, several percent of each of the lights from the semiconductor devices 5a and 5b is reflected and several percent of the light from the semiconductor device 5c is passed by the reflecting mirror 6c. Therefore, since the photosensor 10 is disposed as shown in FIG. 1, several percent of the laser light from the semiconductor laser component 5c and several percent of each of the lights from the semiconductor devices 5a and 5b can be input into the photosensor 10 by the reflecting mirror 6c.

The illuminance sensor 11 detects the illuminance in the periphery of the laser projection/display apparatus 1, and outputs the detected illuminance to the CPU 12. On receiving a signal from the illuminance sensor 11 or a control signal from outside, the CPU 12 supplies a light adjustment request signal for controlling the brightness of the displayed image 13 to be created by the image processing unit 2 to the image processing unit 2.

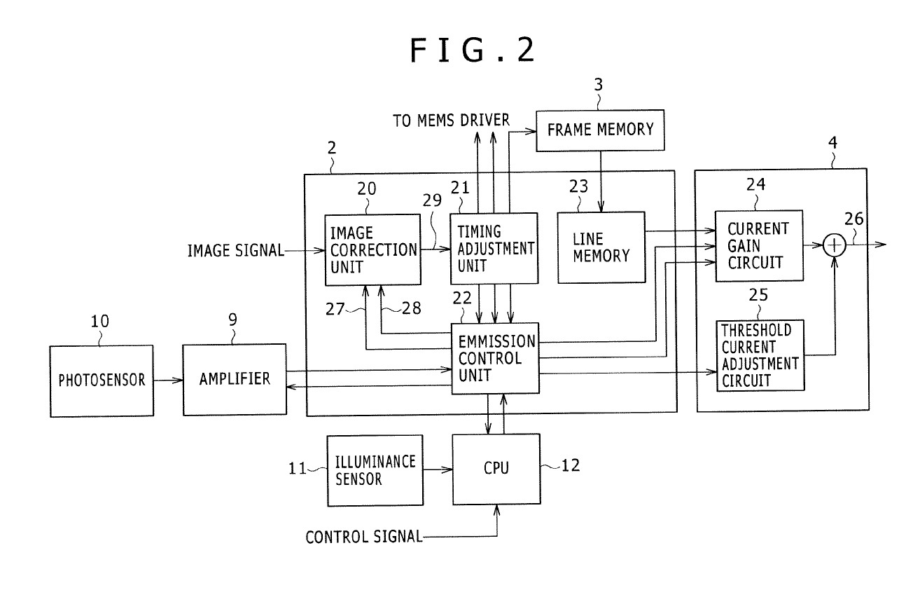

Next, the configuration of this embodiment of the present invention will be explained with reference to FIG. 2.

FIG. 2 is a block diagram showing a signal processing unit according to this embodiment, and shows the internal configurations of the image processing unit 2 and the laser driver 4 in detail. An image signal input from outside the image processing unit 2 is input into an image correction unit 20.

The image correction unit 20 performs an image distortion correction owing to the scanning performed by the MEMS scanning mirror 7 and the image gradation adjustment using an LUT. In the image gradation adjustment performed by the image correction unit 20, an image adjustment on the image signal input from outside is performed on the basis of an LUT selection signal 27 and an LUT update signal 28 sent from an emission control unit 22, and sends the corrected image signal 29 to a timing adjustment unit 21.

The timing adjustment unit 21 creates a horizontal sync signal (also referred to as an H sync signal hereinafter) and a vertical sync signal (also referred to as a V sync signal hereinafter) from the corrected image signal 29, and sends these sync signals to the MEMS driver and the emission control unit 22. In addition, the image signal is temporarily stored in the frame memory 3. The image signal stored in the frame memory is read out by a read-out signal that is created by the timing adjustment unit 21 and is synchronized with both horizontal sync signal and vertical sync signal. Further, the image signal stored in the frame memory 3 is read out after a delay of one frame time relative to the input image signal.

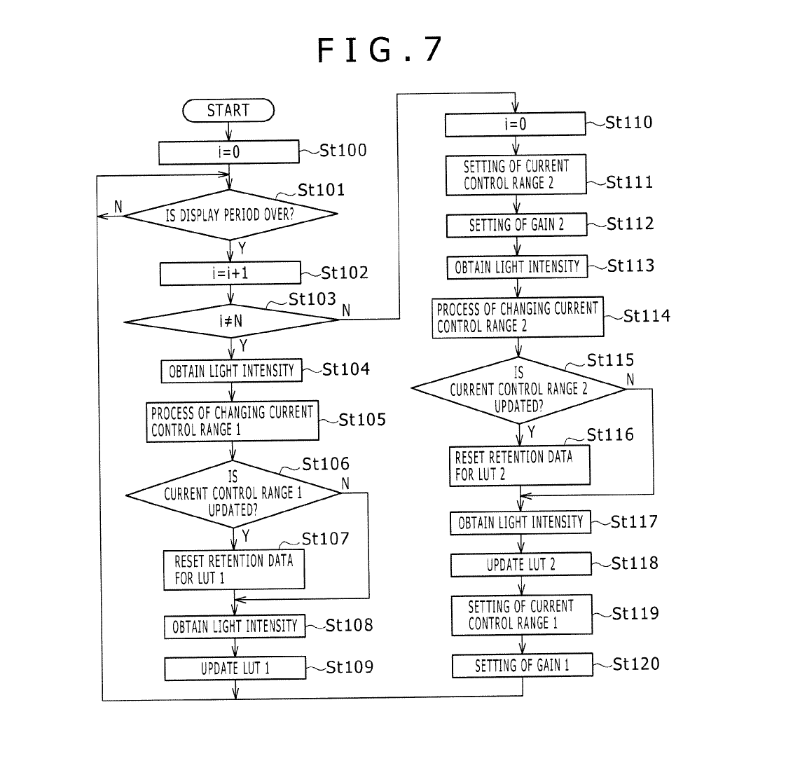

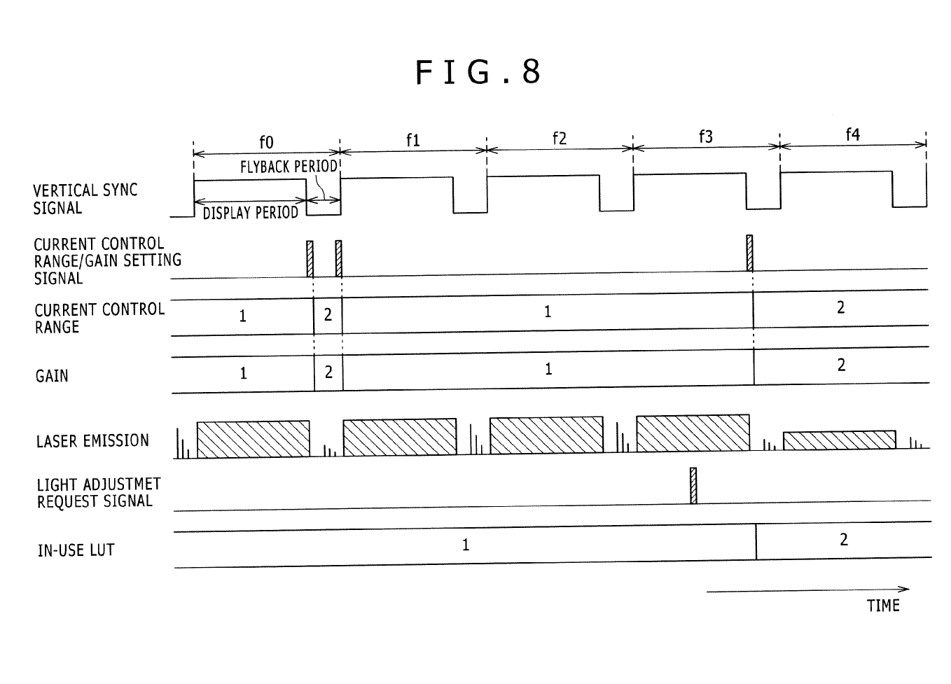

The detailed operation of the emission control unit 22 will be explained later with reference to FIG. 7 and FIG. 8.

The read-out image signal is input into the line memory 23. The line memory 23 brings in part of the image signal for one horizontal period, and the line memory continues to bring in part of the image signal for each horizontal period sequentially. The reason why the image signal is once relayed via the line memory 23 is as follows. Generally speaking, there is a case where the read-out clock frequency of the frame memory 3 is different from the clock frequency of image signal transmission to the laser driver 4. Therefore, after part of the image signal for one horizontal period is readout by the line memory 23 with the read-out frequency of the frame memory 3, and the part of the image signal is read out from the line memory 23 with the clock frequency of image signal transmission. If the read-out clock frequency of the frame memory 3 is the same as the clock frequency of image signal transmission, it is not necessary to install the line memory 23. The image signal read out from the line memory 23 is supplied to the laser driver 4.

Next, a current gain circuit 24 and a threshold current adjustment circuit 25 included in the laser driver 4 will be explained. As described in detail later, the threshold current adjustment circuit 25 adjusts threshold currents that determine lower limits of lights that the semiconductor laser components 5a to 5c emit in accordance with threshold current values set by the emission control unit 22. In other words, the threshold current adjustment circuit 25 creates the offset components of the values of currents flowing through the semiconductor laser components 5a to Sc. In addition, the current gain circuit 24 controls currents flowing through the laser light source 5 that includes the laser components 5a to 5c by multiplying the image signal by current gains in order to convert the image signal values (voltage values) into current values. Here, after calculating the current gains, the emission control unit 22 sets the current gains in the current gain circuit 24. In other words, as the current gains increase or decrease, the current values corresponding to the image signal increase or decrease. Therefore, the values of the currents flowing through the semiconductor laser components 5a to 5c are respectively equal to the sum values of the threshold current values set by the threshold current adjustment circuit 25 and the signal current values corresponding to the current gains set by the current gain circuits 24 and the image signal.

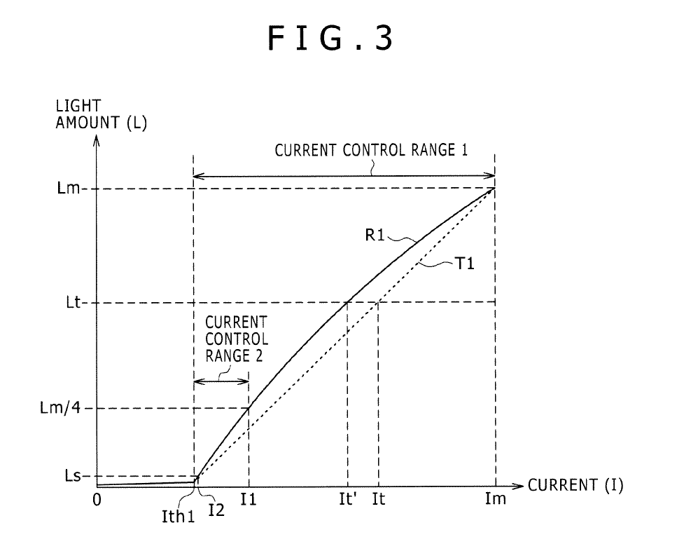

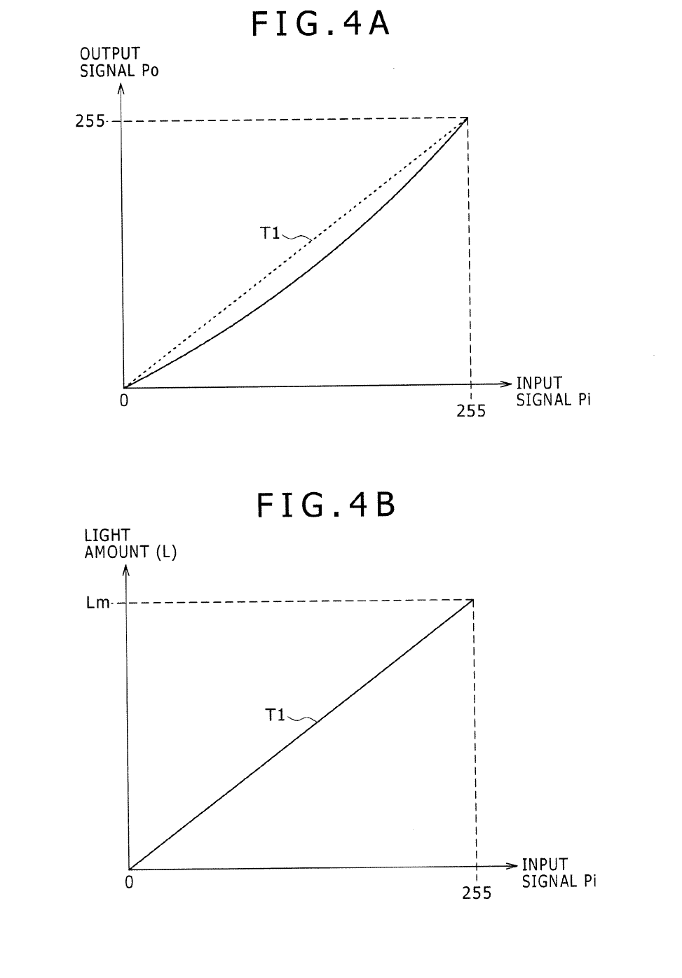

The above is the basic operation of the image processing unit 2. Next, the function of the LUT that is in charge of keeping the number of displayed gradations constant during the operation of the image processing unit 2 will be described with reference to FIG. 3, FIG. 4A, and FIG. 4B.

FIG. 3 is a characteristic diagram showing an example of light amount versus forward current characteristic of a semiconductor laser component. As shown in FIG. 3, the semiconductor laser component has a characteristic showing a drastic increase in its light amount with a certain threshold current Ith1 as a boundary value. In addition, the ratio of the variation of the light amount to the variation of the current is not constant, and it has a nonlinear characteristic shown by R1 in FIG. 3. Here, it is preferable that a current control range used for forming a bright image should be a range from the threshold current Ith1 to a current Im that gives a light amount Lm. In other words, if an image signal is represented by 8 bits, the current gain circuit 24 and the threshold current adjustment circuit 25 have to be controlled so that the forward current is set to Ith1 when the image signal is 0 or 1, and the maximum forward current is set to Im when the image signal is 255. To put it more concretely, the emission control unit 22 controls the threshold current adjustment circuit 25 so that the current is set to Ith1, and sets a current gain (Im−Ith1)/255 in the current gain circuit 24. With the above setting, it becomes possible that the current Ith1 flows through the semiconductor laser component when the image signal is 0, and the current Im flows through the semiconductor laser component when the image signal is 255. In other words, the range of the current flowing through the semiconductor laser component for forming a bright image is a current control range 1 shown in FIG. 3. Further, it is also conceivable to turn off the semiconductor laser component by making the forward current 0 when the image signal is 0 in order to obtain a stronger contrast.

As described above, the ratio of the variation of the light amount to the variation of the current flowing through the semiconductor laser component is not constant within the current control range 1 shown in FIG. 3, and it has the nonlinear characteristic shown by R1. It is desirable that the light amount should have a predefined constant variation versus a constant variation of an image in order to obtain the number of displayed gradations of a displayed image. A procedure for performing the gradation adjustment of an image using an LUT as a means for the light amount to have the predefined constant variation will be explained. For simplification of explanation, the creation procedure of an LUT used for making the output light amount change linearly against an input image signal will be explained hereinafter.

FIG. 4A is a first characteristic diagram for explaining the operation of the LUT according to this embodiment, and FIG. 4A shows a characteristic obtained by converting the characteristic R1 so that a target characteristic T1 shown in FIG. 3 can be obtained. This conversion will be explained below. To explain the conversion using a current value It in FIG. 3, when the current value It flows through the semiconductor laser component, a target light amount Lt can be obtained from an intersection point on the target characteristic T1 corresponding to the current value It. However, because the actual laser characteristic is shown by R1, an actual current value that corresponds to the target light amount Lt is It′. Therefore, an input image signal Pi corresponding to the current value It is converted into an output image signal Po corresponding to the current value It′. With this conversion, a light amount obtained from the input image signal Pi corresponding to the current value It becomes the target light amount Lt. A characteristic obtained when this conversion is applied to all input image signals is an LUT shown in FIG. 4A. Although the characteristic shown in FIG. 4A is a characteristic depicted in an analog fashion, since the LUT is actually given in the form of a numerical table, it is a matter of course that discrete values are given in the LUT.

FIG. 4B is a second characteristic diagram for explaining the operation of the LUT according to this embodiment. With the use of the LUT shown in FIG. 4A as described above, the relation between the output light amount and the input image signal becomes linear as shown in FIG. 42. Although the LUT, which shows that the relation between the output light amount and the input image signal is linear, has been explained so far, it goes without saying that an LUT showing a typical gamma characteristic can be created.

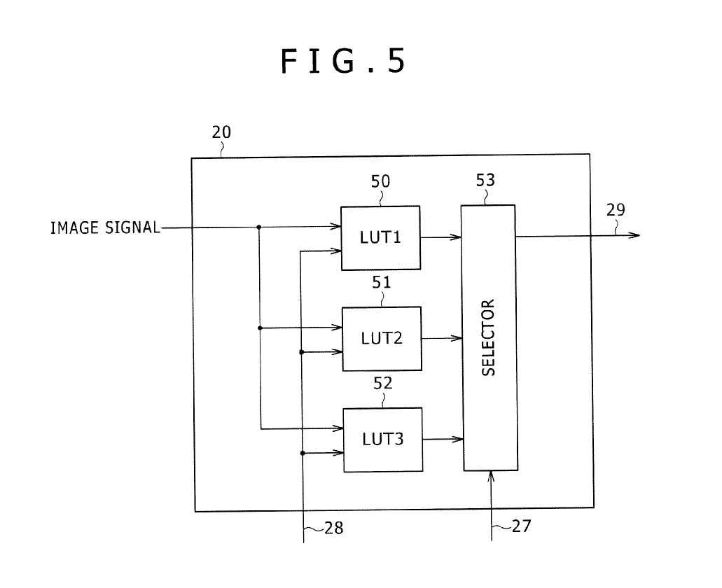

FIG. 5 is a block diagram showing the image correction unit 20 according to this embodiment. Using this block diagram, the operation of the image correction unit 20 will be explained. Here, the image correction unit 20 shown in FIG. 5 has three types of LUTs, that is, LUT1 (50), LUT2 (51), and LUT3 (52), but the configuration of the image correction unit 20 is not limited to this configuration, and the image correction unit 20 can include more than three types of LUTs. Alternatively, as long as any unit that changes an input image into an output image different from the input image, it can be used as the image correction unit 20. However, if the image correction unit 20 has at least two types of LUTs, this embodiment can be realized.

In the image correction unit 20, the input image signal is input into LUT1, LUT2, and LUT3, and outputs, which are described in FIG. 4A, are obtained from respective LUTs in response to the input image signal. The outputs from respective LUTs are input into a selector 53, and the selector 53 outputs an image signal 29 on the basis of the LUT selection signal 27. In addition, the contents of respective LUTs are updated in accordance with the LUT update signal 28 sent from the emission control unit 22. This LUT update procedure will be described later.

One of the features of the first embodiment is to have at least two types of LUTs. Hereinafter, the necessity for the first embodiment to have the at least two types of LUTs will be explained. For example, in the case where the laser projection/display apparatus is used as an in-vehicle display apparatus, it is recommendable that the brightest image in a bright circumstance in the daytime should be projected with the light amount Lm shown in FIG. 3, that is, with the maximum light amount that the laser projection/display apparatus can project. In this case, it is all right if a control range of a current that drives a semiconductor laser component is the current control range 1 shown in FIG. 3. On the other hand, in the case where a vehicle on which the laser projection/display apparatus is mounted is in a dark circumstance such as in a tunnel, if the image is projected with the above brightness as it is, the image gives too bright an impression to a driver. Therefore, it is necessary for the laser projection/display apparatus to instantly switch so that the image is projected with brightness well-adapted to the circumstance of the vehicle. In other words, a light adjustment operation that changes the light intensity of a displayed image of the laser projection/display apparatus in accordance with the circumstance of the vehicle is needed. For an example, in the case where an image changes from a bright image with a brightness during the normal operation (its maximum light amount is Lm) to an image with a brightness, which is one fourth of the brightness of the bright image, during the light adjustment operation (its maximum light amount is Lm/4), the current control range shown in FIG. 3 will be especially discussed.

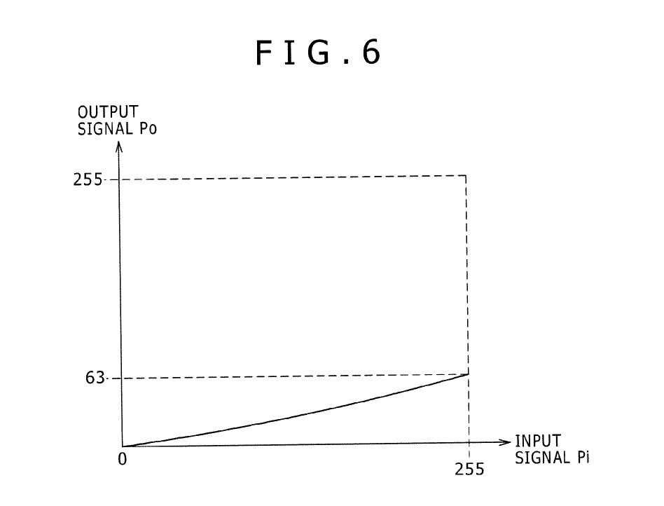

FIG. 6 is a characteristic diagram for explaining the operation of the LUT in the case where the current control range is not changed for both brightnesses. If the current control range remains the above current control range 1, an image whose maximum light amount is Lm/4 can be output by changing the LUT from the LUT having the characteristic shown in FIG. 4A to an LUT having the characteristic shown in FIG. 6. As mentioned above, with the use of at least two types of LUTs, the light adjustment operation can be performed by changing an in-use LUT from one LUT to another or vice versa. However, the LUT shown in FIG. 6 converts an 8-bit input signal (having 256 gradations) into a 6-bit output signal (having 64 gradations). In other words, when the LUT shown in FIG. 6 is used, although the light adjustment operation can be performed, the number of gradations of a displayed image decreases, and the quality of the displayed image decreases.

In order to prevent the decrease of the quality of the displayed image from occurring, it is necessary to change the current control range from the current control range 1 to a current control range 2 shown in FIG. 3. In other words, the current gain circuit 24 and the threshold current adjustment circuit 25 have to be controlled so that the forward current is set to Ith1 when an image signal is 0 or 1, and the maximum forward current is set to I1 when the image signal is 255. To put it more concretely, the emission control unit 22 controls the threshold current adjustment circuit 25 so that the current is set to Ith1, and sets a current gain (Im−Ith1)/255 in the current gain circuit 24. With the above setting, the current Ith1 flows through the laser component when the image signal is 0, and the current I1 flows through the semiconductor laser component when the image signal is 255, which makes it that the brightness of a displayed image can be changed without decreasing the number of gradations of the image.

As is clear from FIG. 3, the table configuration of an LUT corresponding to the current control range 1 and that of an LUT corresponding to the current control range 2 are different from each other, therefore an LUT for the current control range 2 is needed besides an LUT for the current control range 1. However, in this day and age when semiconductor technologies have been highly advanced, it does not become a big problem to prepare plural LUTs.

For example, the emission control unit 22 quickly switches the image correction unit 20 so that, when a bright image (its maximum light amount is Lm) is output, the current control range 1 and LUT1 corresponding to the current control range 1 are used, and when an image whose brightness is one fourth of the brightness of the bright image (its maximum light amount is Lm/4) is output, the current control range 2 and LUT2 corresponding to the current control range 2 are used. With the above-described procedure, the number of displayed gradations can be kept constant without decreasing the number of gradations of a displayed image during the light adjustment operation. As described above, with the use of at least two types of LUTs corresponding to at least two types of current control range, the number of displayed gradations can be kept constant during the light adjustment operation. Although the above description has been made using the current control range 1 within which the maximum light amount is Lm, and the current control range 2 within which the maximum light amount is Lm/4 in the above example, the number of the current control ranges is not limited to two, and it goes without saying that plural current control ranges and plural LUTs corresponding these current control ranges can be prepared for realizing this embodiment.

The basic operation of the laser projection/display apparatus according to this embodiment has been explained so far. In this embodiment, the number of displayed gradations can be kept constant even during the light adjustment operation, and at the same time, a change in the white balance of a displayed image owing to the variation in temperature can be reduced. A concrete operation example in this case will be explained by focusing our discussion mainly on the operation of the emission control unit 22.

FIG. 7 is a flowchart showing the entire processing of the first embodiment. FIG. 7 shows an example of the case where the current control range of a displayed image is the current control range 1, and LUT1 is used.

After the power supply is turned on, the emission control unit 22 resets a variable i (at step St100). The variable i works as a frame number counter, and operates as a counter that controls the frequency of performing normal operation processing and the frequency of performing light adjustment operation processing. After resetting the variable i, the emission control unit 22 judges whether a display period is over or not on the basis of the vertical sync signal sent from the timing adjustment unit 21 (at step St101). During a flyback period after the display period is over, the emission control unit 22 increments the variable i (at step St102). Subsequently, the variable i is compared with a predefined number N that defines the frequency of performing the normal operation processing and the frequency of performing the light adjustment operation processing (at step St103). If the variable i is not equal to the predefined number N, the flow proceeds to the normal operation processing through step St104 to step St109. If the variable i is equal to the predefined number N, the flow proceeds to the light adjustment operation processing through step St110 to step St120.

The normal operation processing and the light adjustment operation processing, both of which will be described later, are performed not during a display period but during a flyback period lest either of the processing steps should have an adverse effect on an image to be projected and displayed. In addition, the frequency of the normal operation processing and the frequency of the light adjustment operation processing are determined using the predefined number N in accordance with the priorities of these processing steps, and for example, the former processing is performed (N−1) times per N frames, and the latter processing is performed once per N frames. Here, the number N can be a constant number or a variable number.

The normal operation processing through step St104 to step St109 will be explained below. Generally speaking, a semiconductor laser component has temperature characteristics. For example, the semiconductor laser component has a characteristic that its threshold current at which emission starts becomes large, and also has a characteristic that the gradient of light amount versus current becomes small as temperature rises. Therefore, in order to make the light emission intensity of the semiconductor laser component constant with time, it is necessary to perform APC (Auto Power Control) in which the light amount is detected by the photosensor 10, and monitored via the amplifier 9, and the obtained emission intensity is fed back to the current gain circuit 24 and the threshold current adjustment circuit 25. As an example, the maximum image signal is transmitted from the emission control unit 22 to the current gain circuit 24 as an image signal, the light intensity of the image signal is detected by the photosensor 10, and the light intensity is obtained via the amplifier 9. Subsequently, the obtained light intensity is compared with the target light amount Lm, and a gain to be set in the current gain circuit 24 so that an output light amount at the time when the maximum image signal is input becomes Lm is feedback controlled.

In addition, in order to determine a setting value to be given to the threshold current adjustment circuit 25, an image signal corresponding to the threshold current Ith1 or corresponding to a current in the vicinity of the threshold current Ith1 is transmitted to the current gain circuit 24 as an image signal, the light intensity of the image signal is detected by the photosensor 10, and the light intensity is obtained via the amplifier 9. Subsequently, a current value to be set in the threshold current adjustment circuit 25 is feedback controlled so that the light intensity of the image signal becomes an output light amount at the time when the image signal corresponding to the threshold current Ith1 or corresponding to the current in the vicinity of the threshold current Ith1 is input. With the above configuration, although the current control range 1 varies with time, the output light amount corresponding to the input image signal becomes constant, which can make a user unconscious of the variations of characteristics of the semiconductor laser component. Here, the above output light amount Lm and the output light amount at the time when the image signal corresponding to the threshold current Ith1 or corresponding to a current in the vicinity of the threshold current Ith1 is input are retained in advance in a not-shown memory area. In addition, the white balance can be kept constant by retaining the values of light amounts corresponding to respective RGB colors. Although, for simplification for explanation, the light intensity that is detected by the photosensor 10 and obtained via the amplifier 9 has been assumed to be the light intensity of the maximum image signal or the light intensity of an image signal corresponding to the threshold current Ith1 or corresponding to a current in the vicinity of the threshold current Ith1, the light intensity is not limited to the above image signals, and it goes without saying that it is all right if a light intensity of a given image signal is detected by the photosensor 10 and obtained via the amplifier 9.

In order to perform the above-described normal operation processing, a semiconductor laser component is made to emit a light with a given light intensity within the current control range 1 during a flyback period, the light intensity is detected by the photosensor 10, and the light intensity is obtained via the amplifier 9 (at step St104). Whether the current control range 1 is changed or not is judged on the basis of this obtained light intensity, and a process in accordance with the judgment result is performed (at step St105). Here, the judgment whether the current control range 1 is changed or not can be made on the basis of the light intensity by the emission control unit 22, or by the CPU 12 after the emission control unit 22 transmits the light intensity information to the CPU 12. At step St106, whether the current control range 1 is updated or not, that is, whether at least one of the setting values of the current gain circuit 24 and the threshold current adjustment circuit 25 is changed or not is judged, and if the current control range 1 is updated, the flow proceeds to step St107. In the case where the current control range 1 is updated, retention data for LUT1 obtained during past frames is reset at step St107, and the flow proceeds to step St108. With that, the processing regarding the current control range 1 is over, and the current control range 1 is updated if necessary.

At step St108, a light intensity corresponding to an image signal is obtained. Here, it is desired that light intensities corresponding to plural image signals should be obtained at step St108. In addition, the obtained light intensities can be stored in a not-shown memory area as retention data for LUT1, or after the emission control unit 22 transmits the light intensity information to the CPU 12, the CPU 12 can retain this information. Here, the retention data for LUT1 is data used for updating data of LUT1. Since an image signal can be converted into the value of a current flowing through a semiconductor laser component, it is possible to create a light amount versus forward current characteristic of the semiconductor laser component within the current control range 1 by obtaining light intensities corresponding to image signals, and this light amount versus forward current characteristic of the semiconductor laser component is set to retention data for LUT1.

LUT1 is updated by performing the conversion explained in the above FIG. 4A using the retention data for LUT1 (at step St109). Here, the calculation for updating LUT1 can be performed by either the emission control unit 22 or the CPU 12. In addition, it is also conceivable that a large number of light intensities are obtained across plural frames at step St108 before the current control range 1 is updated, and LUT1 is updated after a certain amount of retention data for LUT1 is stored. As described above, it becomes possible to cope with the time degradation of the semiconductor laser component by appropriately updating data for LUT1 during the normal operation.

The above is the explanation of the normal operation through step St104 to step St109. In other words, LUT1 within the current control range 1 shown in FIG. 3 is updated in accordance with light intensities of given image signals detected in flyback periods. In this case, light intensities regarding given image signals, for example, regarding image signals with the gradation 0 and gradation 255, are detected at step St104, and whether the current control range 1 is updated or not is determined on the basis of these intensities at step St105. If the current control range 1 is determined to be updated, data that has been retained up to now regarding LUT1 is reset at step St107. Next, light intensities corresponding to plural image signal levels within the current control range 1 at the present time are detected at step St108, new data used for updating LUT1 is obtained by converting the detected light intensities as explained in FIG. 4A, and LUT1 is updated at step St109. The abovementioned flow through step St104 to step St109 is performed in flyback periods when the variable i is not equal to the predefined number N as the result of the judgment at step St103.

Next, intensity changing processing for light adjustment operation performed through step St 110 to step St120 when it is judged that the variable i is equal to the predefined number N at step St103 will be explained.

If the variable i is equal to the predefined number N at step St103, the flow proceeds to step St110 and the variable i is reset. Next, the current control range is changed from the current control range 1, which is the current control range for the normal operation period, to the current control range 2 (at step St111). By changing the current control range as above, the number of gradations can be kept constant even during the light adjustment operation. Next, the emission control unit 22 changes the gain for the amplifier 9 from the gain 1 corresponding to the current control range 1 that is the current control range for the normal operation period to the gain 2 corresponding to the current control range 2 (at step S0112). These gains relate to the outputs from the photosensor, and it is desirable that the gain 1 corresponding to the current control range 1 whose maximum light amount is Lm and the gain 2 corresponding to the current control range 2 whose maximum light amount is Lm/4 should be different from each other.

For example, in the case where the amplifier 9 outputs a laser light amount, which ranges from 0 to Lm, with 10-bit number (its maximum is 1023) within the current control range 1, if the laser light amount, which ranges from 0 to Lm/4 within the current control range 2, is detected by the same gain, the light intensity of the latter laser light is obtained with only 8-bit accuracy. Therefore, if the gain 2 corresponding to the current control range 2 is set to one fourth of the gain 1 corresponding to the current control range 1, the output of the amplifier 9 can be obtained with 10-bit accuracy. As described above, by setting a gain corresponding to the set current control range in the amplifier 9, data of light intensities can be obtained with high accuracy.

After the gain 2 is set at step St112, a semiconductor laser component is made to emit a light with a given light intensity within the current control range 2, the light intensity is detected by the photosensor 10, and the light intensity is obtained via the amplifier 9 (at step St113). Whether the current control range 2 is changed or not is judged on the basis of this obtained light intensity, and a process in accordance with the judgment result is performed (at step St114). Here, the judgment whether the current control range 2 is changed or not can be made on the basis of the light intensity by the emission control unit 22, or by the CPU 12 after the emission control unit 22 transmits the light intensity information to the CPU 12. At step St114, whether the current control range 2 is updated or not, that is, whether at least one of the setting values of the current gain circuit 24 and the threshold current adjustment circuit 25 is changed or not is judged, and if the current control range 2 is updated, the flow proceeds to step St116. In the case where the current control range 2 is updated, retention data for LUT2 obtained during past frames is reset at step St116, and the flow proceeds to step St117.

At step St117, a light intensity corresponding to an image signal is obtained. Here, it is desired that light intensities corresponding to plural image signals should be obtained at step St117. In addition, the obtained light intensities can be stored in a not-shown memory area as retention data for LUT2, or after the emission control unit 22 transmits the light intensity information to the CPU 12, the CPU 12 can retain this information. Here, the retention data for LUT2 is data used for updating data of LUT2. Since an image signal can be converted into the value of a current flowing through a semiconductor laser component, it is possible to create a light amount versus forward current characteristic of the semiconductor laser component within the current control range 2 by obtaining light intensities corresponding to image signals, and this light amount versus forward current characteristic of the semiconductor laser component is set to retention data for LUT2.

LUT2 is updated by performing the conversion explained in the above FIG. 4A using the retention data for LUT2 (step St118). Here, the calculation for updating LUT2 can be performed by any of the emission control unit 22 and the CPU 12. In addition, it is also conceivable that a large number of light intensities are obtained across plural frames at step St117 before the current control range 2 is updated, and LUT2 is updated after a certain amount of retention data for LUT2 is stored. As described above, it becomes possible to cope with the time degradation of the semiconductor laser component by appropriately updating data for LUT2 during the light adjustment operation.

Next, before a display period begins, the current control range is changed from the current control range 2 to the current control range 1 (at step St119). In addition, the emission control unit 22 changes the gain for the amplifier 9 from the gain 2 corresponding to the current control range 2 to the gain 1 corresponding to the current control range 1 (at step St120), and the flow goes back to step St101 to repeat the abovementioned processing.

The above is the explanation of the intensity changing processing for light adjustment operation through step St110 to step St120. In other words, LUT2 within the current control range 2 shown in FIG. 3 is updated in accordance with light intensities of given image signals detected in a flyback period. In this case, light intensities regarding given image signals, for example, regarding image signals with the gradation 0 and gradation 255, are detected at step St113, and whether the current control range 2 is updated or not is determined on the basis of these intensities at step St114. If the current control range 2 is determined to be updated, data that has been retained up to now is reset at step St116. Next, light intensities corresponding to plural image signal levels within the current control range 2 at the present time are detected at step St117, new data used for updating LUT2 is obtained by converting the detected light intensities as explained in FIG. 4A, and LUT2 is updated at step St118. Subsequently, the flow goes back to step St101 via step St119 and step St120. The abovementioned flow through step St110 to step St120 is performed in flyback periods when the variable i is equal to the predefined number N as the result of the judgment at step St103.

As described above, the light adjustment operation processing is processing that sets a current control range and a gain of the amplifier 9, which are respectively different from those used for the normal operation period, and updates a current control range set during the light adjustment operation and an LUT corresponding to the current control range in a flyback period. With the above-described processing, because it becomes possible that a current control range applied to the light adjustment operation and an LUT corresponding to the current control range can be created in advance, the laser projection/display apparatus can promptly switch the brightness of an image with the number of displayed gradations kept constant.

Although the description in FIG. 7 has been made under the assumption that the current control range during the normal operation period is the current control range 1, and the current control range during the light adjustment operation period is the current control range 2, the types of current control ranges are not limited to the above two types, and it is conceivable that more than two current control ranges are used by preparing more than two branches at step St103. In addition, it goes without saying that, after the light control range 2 is updated during the light control operation processing, similar processing steps can be performed using current control ranges, each of which is different from the current control range 2 during the light adjustment operation processing steps during the subsequent frames, that is, time division processing steps can be performed.

Next, a concrete timing chart during the light adjustment operation using the flowchart shown in FIG. 7 (OK) will be explained with reference to FIG. 8.

FIG. 8 is a timing chart showing the entire processing of the first embodiment, and shows timings regarding a vertical sync signal, a current control range, a gain setting signal, a gain, a laser emission, a light adjustment request signal, and an in-use LUT. The light adjustment operation processing is performed during the flyback period of the frame f0, and the normal operation processing is performed during the flyback periods of the frame f1 and frame f2. In addition, regardless of these processing steps, the light adjustment request signal, which is issued by the CPU 12 on the basis of the detection result of the brightness in the vicinity of the laser projection/display apparatus detected by the illuminance sensor 11 shown in FIG. 2, appears during the frame f3. Here, it will be assumed that the light adjustment request signal is a signal requesting the change from the current control range 1 to the current control range 2.

First, if i=N at step St103 in FIG. 7 after the display period of the frame f0 is over, the flow proceeds to the light adjustment operation processing. Next, the current control range 2 and the gain 2 are set (at step Still and step St112). Subsequently, the emission control unit 22 makes the semiconductor laser components 5a to 5c emit lights with their light intensities corresponding to plural points within the current control range 2, makes the photosensor 10 detect their light intensities, and obtains their light intensities via the amplifier 9 (at step St113 or step St117). After the process of changing the current control range 2 and the update of LUT2, both of which are not shown in FIG. 8, are over (at step St114 and step St118 respectively), the current control range 1 and the gain 1 are set (at step 119 and step St120), and the flow proceeds to the frame f1.

Next, since i≠N at step St103 in FIG. 7 after the display period of the frame 1 is over, the flow proceeds to the normal operation processing. The emission control unit 22 makes the semiconductor laser components 5a to 5c emit lights with their light intensities corresponding to plural points of the current control range 1, makes the photosensor 10 detect their light intensities, and obtains their light intensities via the amplifier 9 (at step St104 or step St108). After the process of changing the current control range 1 and the update of LUT1, both of which are not shown in FIG. 8, are over (at step St105 and step St109 respectively), the flow proceeds to the frame f2. The normal operation processing is performed during the flyback period of the frame f2 as is the case with the frame f1.

Next, the case where the light adjustment request signal is input into the emission control unit 22 during the frame f3 will be explained. The light adjustment request signal is temporarily retained in the emission control unit 22. The emission control unit 22 sets the current control range 2 and the gain 2, both of which are created in advance, during the flyback period of the frame f3, and supplies the LUT selection signal 27 to the image correction unit 20 so that the LUT 2 is selected. Changing the current control range during the flyback period in such a way can suppresses an uncomfortable feeling that is brought about by a part of an image suddenly getting dark. In addition, the target of the normal operation processing becomes the current control range 2 from the flyback period of the frame f3, and the brightness of the display during a display period becomes the brightness of the light adjustment operation. With the above-described processing, an image with its brightness well-adapted to the circumstance can be projected.

Therefore, the normal operation processing corresponding to the current control range 2 is performed during the flyback period of the frame f3 in FIG. 8, and intensity changing processing steps for light adjustment operation corresponding to the not-shown current control ranges other than the current control range 2 are performed at an arbitrary frequency during the flyback periods of frames subsequent to the frame f3. As described above, according to this embodiment, because a current control range applied to the light adjustment operation and an LUT corresponding to the current control range can be created in advance, the laser projection/display apparatus can promptly switch the brightness of an image with the number of displayed gradations kept constant just after the input of the light adjustment request signal.

In other words, when the light adjustment request signal is input, the light adjustment operation processing is performed in the flyback period regardless of the value of the abovementioned i, and the light adjustment operation is started at the display period of the subsequent frame. The light adjustment operation is performed using the current control range 2 and LUT2 for the light adjustment operation both of which are prepared in the flyback period of the normal operation. Here, it is conceivable that the light adjustment request signal is issued in response not only to the detection result of the brightness detected by the illuminance sensor 11 but also to a user's request.

According to this embodiment, it is possible to provide a laser projection/display apparatus having a little change in the white balance of a displayed image owing to the variation in temperature while keeping the number of displayed gradations constant during its light adjustment operation.

Although the laser projection/display apparatus according to this embodiment has been described in such a way that, during the light adjustment operation processing, a current control range and a gain of the amplifier 9, both of which are different from those for a display period, are set for a flyback period, and a current control range applied to the light adjustment operation and an LUT corresponding to the current control range are created in advance, it is conceivable that either the current control range or the gain is changed during the light adjustment operation processing. For example, if step St112 and step St120 are deleted in FIG. 7, because the accuracies of data of light intensity obtained at step St113 and step St117 are not improved, the accuracy of LUT2 corresponding to the current control range 2 is deteriorated. However, it is conceivable that, by data interpolation performed by the emission control unit 22, the CPU 12, or the like using the retention data for LUT2, a simplified LUT2 is created, and LUT2 is updated by the simplified LUT2 (at step St118). There is an advantage in that the configuration of the laser projection/display apparatus is simplified by the above simplification. In addition, after the light adjustment is performed, the accuracy of the simplified LUT2 is improved through step St 109 during the normal operation processing.

### Second Embodiment

In the above first embodiment, the description has been made about the laser projection/display apparatus that is configured in such a way that, during the light adjustment operation processing, a current control range and a gain of the amplifier 9, both of which are different from those for a display period, are set for a flyback period, and a current control range applied to the light adjustment operation and an LUT corresponding to the current control range are created in advance.

Other than the above control method, a method, in which, after a light adjustment request signal is input, a current control range applied to the light adjustment operation and an LUT corresponding to the current control range are determined, is conceivable. In this case, although the light adjustment operation cannot be performed immediately after the light adjustment request signal is input, the number of displayed gradations can be kept constant before and after the light adjustment operation. In addition, in this control method, since a current control range applied to the light adjustment operation and an LUT corresponding to the current control range are determined after the light adjustment request signal is input, the number of required LUTs can be reduced, which can make the size of the circuit smaller. Further, since it is not necessary to perform the intensity changing processing for light adjustment operation until the light adjustment request signal is input, intensity changing processing for normal operation can be performed during every frame until the light adjustment request signal is input.

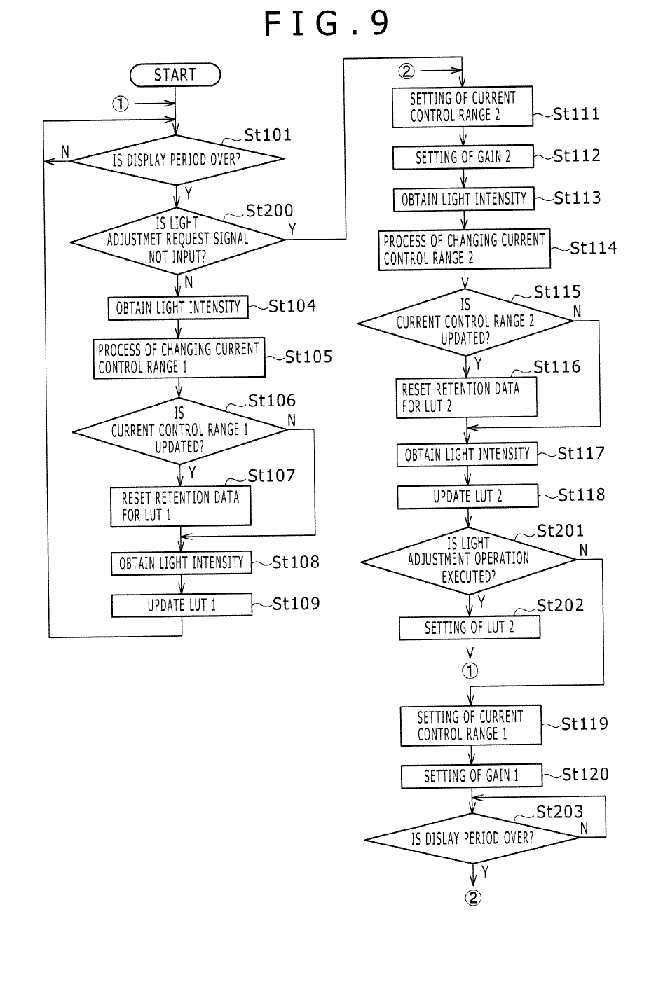

Hereinafter, a configuration, in which a current control range applied to the light adjustment operation and an LUT corresponding to the current control range are determined after this light adjustment request signal is input, will be explained with reference to FIG. 9 to FIG. 11 as a second embodiment. Here, components having the same configurations and functions as those of components of the first embodiment are denoted by the same reference numerals, and detailed explanations thereof will be omitted.

FIG. 9 is a flowchart showing the entire processing of the second embodiment. The flowchart shown in FIG. 9 shows an example in which the current control range of a displayed image is the current control range 1 and LUT1 is used. In addition, it is supposed that the light adjustment request signal used in this flowchart is a signal used for changing the current control range from the current control range 1 to the current control range 2. For example, the light adjustment request signal is a signal that the CPU 12 issues in accordance with the result of the brightness in the vicinity of the apparatus detected by the illuminance sensor 11 shown in FIG. 2.

After the power supply is turned on, the emission control unit 22 judges whether a display period is over or not on the basis of the vertical sync signal transmitted from the timing adjustment unit 21 (step St101). After the display period is over and the flyback period begins, the emission control unit 22 judges whether the light adjustment request signal is input or not (step St200). If the light adjustment request signal is not input, the flow proceeds to the normal operation processing through step St104 to step St109 as is the case with the first embodiment.

If it is judged that the light adjustment request signal is input at step St200, the flow proceeds to step Still, and the current control range is changed from the current control range 1, which is the current control range for the normal operation period, to the current control range 2 (at step St111). Subsequently, step St 112 to step St118 are performed as is the case with the first embodiment. Next, it is judged whether the light adjustment operation is performed or not as step St201. In this case, whether the light adjustment operation is performed or not is judged by the emission control unit 22, and it is assumed that the light adjustment operation is performed after the simplified update of LUT2 or the update of LUT2 after the elapse of a predefined time is performed. The difference between these two updates will be explained with reference to the later-described timing chart.

If it is judged that the light adjustment operation is performed t step St201, the flow proceeds to step St202, and the LUT selection signal 27 is supplied to the image correction unit 20 so that LUT2 is selected as an LUT used in the display period. After step St202, the current control range 2 becomes the target of the normal operation processing, and the intensity changing processing for normal operation through step St104 to step St109 is performed during flyback periods until the next light adjustment request signal is input.

If it is judged that the light adjustment operation is not performed at step St201, the current control range is changed from the current control range 2 to the current control range 1 before a display period begins (at step St119). In addition, the emission control unit 22 changes the gain for the amplifier 9 to amplify the output from the photosensor 10 from the gain 2 corresponding to the current control range 2 to the gain 1 corresponding to the current control range 1 (at step St120). Subsequently, the emission control unit 22 judges whether the display period is over or not on the basis of the vertical sync signal sent from the timing adjustment unit 21 at step St203, and the flow proceeds to step Still during the flyback period after the display period is over.

As described above, after the light adjustment request signal is input, by setting a current control range and a gain of the amplifier 9, which are different from those for the normal operation period, and by updating a current control range set during the light adjustment operation and an LUT corresponding to the current control range in a flyback period, the brightness of the image can be switched while the number of displayed gradations is kept constant. Further, since it is not necessary to perform the intensity changing processing for light adjustment operation until the light adjustment request signal is input, the intensity changing processing for normal operation can be performed during every frame until the light adjustment request signal is input.

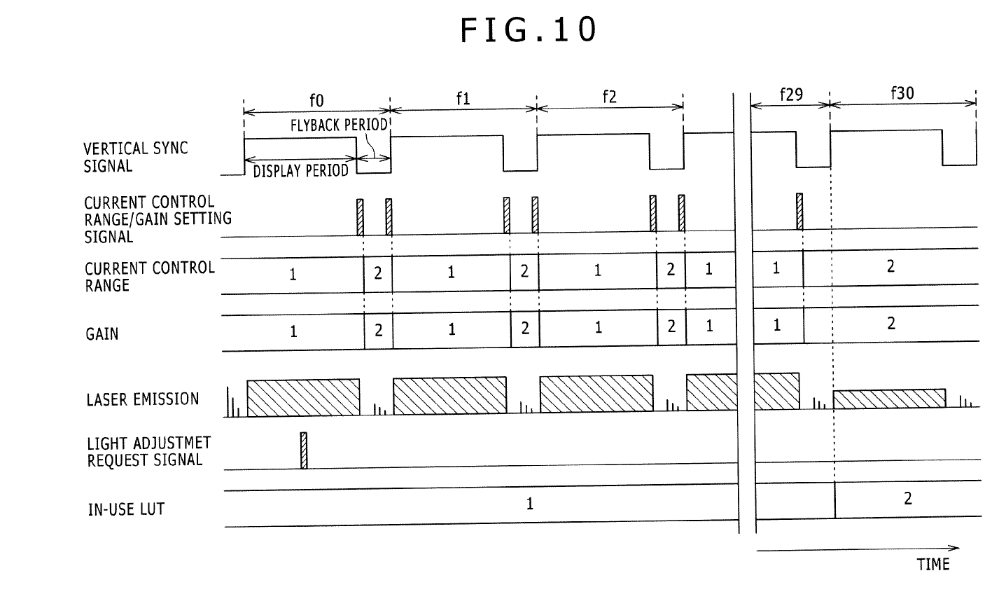

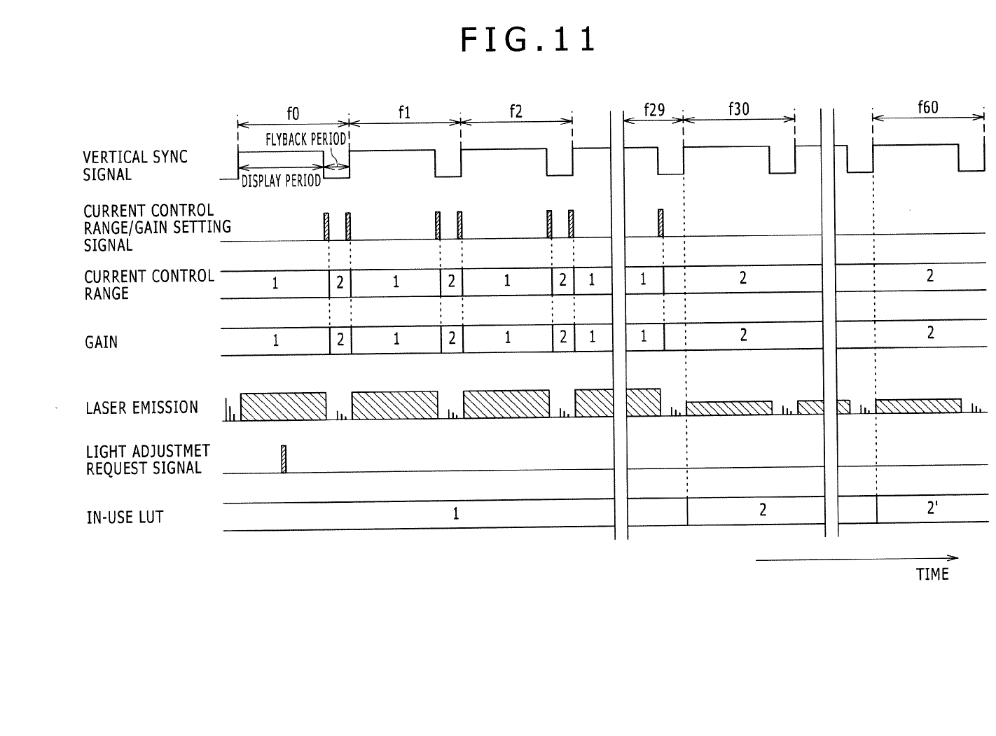

Next, a concrete timing chart during the light adjustment operation using the flowchart shown in FIG. 9 will be explained with reference to FIG. 10 and FIG. 11.

FIG. 10 is a timing chart showing the entire processing of the second embodiment, and this timing chart is a timing chart in the case where it is judged that the light adjustment operation is performed after the simplified update of LUT2 is performed at step St201.

FIG. 11 is a timing chart showing the entire processing of another configuration according to the second embodiment, and this timing chart is a timing chart in the case where it is judged that the light adjustment operation is performed at step St102 after the update of LUT2 is performed after the elapse of a predefined time.

FIG. 10 is a flowchart showing the case where the light adjustment request signal appears during the frame f0. Here, it will be assumed that the light adjustment request signal is a signal requesting the change from the current control range 1 to the current control range 2. First, it is judged that the light adjustment request signal is input after the display period of the frame f0 is over (at step St200), and the current control range 2 and the gain 2 are set (at step Still and step St112). Subsequently, the emission control unit 22 makes the semiconductor laser components 5a to 5c emit lights with their light intensities corresponding to plural points within the current control range 2, makes the photosensor 10 detect their light intensities, and obtains their light intensities via the amplifier 9 (at step St113 or step St117). After the process of changing the current control range 2 and the update of LUT2, neither of which is shown in FIG. 10, are over (at step St114 and step St118 respectively), it is judged whether the simplified update of LUT2 has been performed or not, and it is judged whether the light adjustment operation is perform3d or not (at step St201).

Here, the simplified update of LUT2 means processing in which a large number of light intensities are obtained through plural frames at step St117 and LUT2 is updated after a certain amount of retention data for LUT2 is stored. In this case, it is desirable that the above certain amount of retention data is data corresponding to 25 or more of all expressible image signals. In other words, the simplified update of LUT2 means updating LUT2 at step St118 after obtaining light intensities corresponding to 64 gradations or larger as retention data for LUT2 in the case of an image signal having 8-bit gradation (the maximum gradation level is 255). In addition, it is desirable that, by allocating the gradations of images to be obtained at even intervals across all expressible image signals, light intensities corresponding to the gradations of image signals are all-roundly obtained. With the above-described processing, the errors of interpolating processing performed for non-obtained image signals can be reduced.

In the frame f0 shown in FIG. 10, since it is judged that the simplified update of LUT2 is not performed, and the light adjustment operation is not performed, the current control range 1 and the gain 1 are set at step St119 and step St120 respectively, and the flow proceeds to the frame f1. The processing through step Still to step St120 is performed during the flyback period of the frame f1 as is the case with the frame f0.

Next, the case where the simplified update of LUT2 is completed at step St118 during the flyback period of the frame f29 will be explained. During the frame f29, the emission control unit 22 at step St201 judges that the simplified update of LUT2 is completed, and determines to perform the light adjustment operation. In other words, the flow proceeds to step St202, and after the emission control unit 22 changes the in-use LUT from LUT1 to LUT2, the flow goes back to step St101. Therefore, the current control range 2 becomes the target of the normal operation processing from the frame f30, which is the subsequent frame, and the normal operation processing is performed during the flyback period of every frame until the next light adjustment request is input.

In other words, during flyback periods after the light adjustment request signal is received, light intensity data at plural points within the current control range 2 across plural frame periods are obtained although the obtained light intensity data does not cover all gradations, with the result that LUT2 is updated using this obtained light intensity data. During flyback periods and display periods after the simplified update of LUT2 is completed, an operation based on the current control range 2, that is, the light adjustment operation is performed.

A timing chart shown in FIG. 11 is different from the timing chart shown in FIG. 10 in that the update processing of LUT2 during the flyback period of the frame 29 at step St118 in FIG. 11 is different from that in FIG. 10. In FIG. 11, a not-shown frame counter counts elapsed time from the time when the light adjustment request signal is input, and after a predetermined time elapses, it is determined that the light adjustment operation is forcibly performed at step St201. In other words, the flow proceeds to step St202, and after the in-use LUT is set to change from LUT1 to LUT2, the flow goes back to step St101. Therefore, the current control range 2 becomes the target of the normal operation processing from the frame f30, which is the subsequent frame, and the normal operation processing is performed during the flyback period of every frame until the next light adjustment request is input. In the meantime, since LUT2 is updated as needed, LUT2′, which is different from LUT2, is used, for example, in the frame f60 in FIG. 11.

Since LUT2 shown in FIG. 11 is updated by data obtained during the time from the input of the light adjustment request signal to the elapse of the predefined time, the accuracy of the update is not so high as that of the above-described simplified update of LUT2. However, the light adjustment operation is performed after the elapse of the predefined time in order to make a time from the input of the light adjustment request signal to the performance of the light adjustment operation as short as possible. Here, it is desirable that the above predefined time should be 1 second or less. It is because, if the time from the input of the light adjustment request signal to the performance of the light adjustment operation is 1 second or more, a user may experience an uncomfortable feeling.

As described above, according to this embodiment, after the light adjustment request signal is input, a current control range and a gain, both of which are different from those for the normal operation period, are set, and a current control range set during the light adjustment operation and an LUT corresponding to the current control range are updated in a flyback period, which enables the brightness of an image to be promptly switched with the number of displayed gradations kept constant, and at the same time, enables a change in the white balance of a displayed image owing to the variation in temperature to be reduced.

### Third Embodiment

In the above-described first embodiment or the second embodiment, a configuration in which a current control range applied to the light adjustment operation and an LUT corresponding to the current control range are created has been explained. Other than the above control method, another method is conceivable in which plural fixed LUTs are prepared in advance in a not-shown memory area, and a current control range applied to the light adjustment operation is determined. Even in this case, the light adjustment operation can be achieved immediately after a light adjustment request signal is input, and the number of displayed gradations can be kept constant before and after the light adjustment operation. In addition, because this control method does not request the update of the LUT, the size of the circuit can be reduced, and the load on the CPU can be small during light adjustment operation.

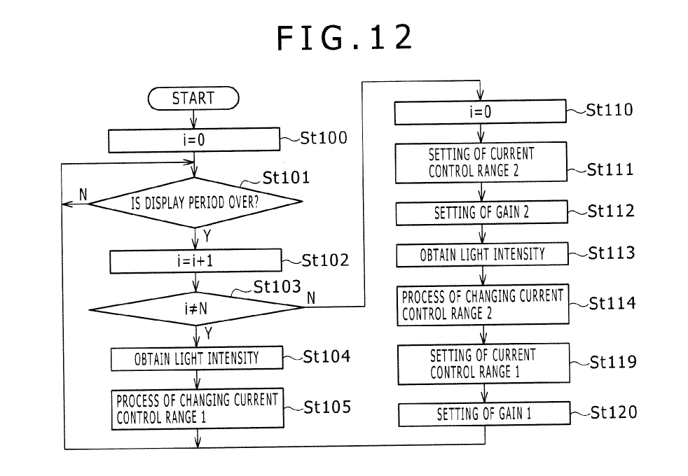

Hereinafter, a configuration, in which plural fixed LUTs are prepared in advance in this not-shown memory area, and a current control range applied to the light adjustment operation is determined, will be explained as a third embodiment of the present invention with reference to FIG. 12. Here, components having the same configurations and functions as those of components of the first embodiment are denoted by the same reference numerals, and detailed explanations thereof will be omitted.

Here, the above output light amount Lm and the output light amount at the time when the image signal corresponding to the threshold current Ith1 or corresponding to a current in the vicinity of the threshold current Ith1 is input are retained in advance in a not-shown memory area. In addition, the white balance can be kept constant by retaining the values of the abovementioned light amounts corresponding to respective RGB colors.

FIG. 12 is a flowchart showing the entire processing of the third embodiment. FIG. 12 shows an example in which the current control range of a display image is the current control range 1, and LUT1 is used. In addition, FIG. 12 is a flowchart obtained by deleting steps St106 to St 109 and steps St115 to St118 from FIG. 7. Therefore, items regarding steps St100 to St105, steps St110 to St114, step St119, and step St120 will be simply described without describing many items already-described in the first embodiment.

As described above, the third embodiment is configured in such a way that plural fixed LUTs corresponding to information regarding output light amounts and current control ranges are prepared in advance, and one of these fixed LUts is selected in accordance with a light intensity measured during a flyback period by the photosensor 10. Therefore, processing used for updating an in-use LUT in accordance with a measured light intensity becomes unnecessary, so that steps St106 to St109, and steps St115 to St118 shown in FIG. 7 are omitted in FIG. 12.

In the case where the intensity changing processing for normal operation (Y at step St103) is selected, the emission control unit 22 makes the semiconductor laser components 5a to Sc emit lights corresponding light intensities at plural points within the current control range 1 during the flyback period, makes the photosensor 10 detects the light intensities, and obtains the light intensities via the amplifier 9 (at step St104). It is judged whether the current control range 1 is changed or not on the basis of this obtained light intensities, and if the current control range 1 is changed, an LUT corresponding to the new current control range is selected out of the fixed LUTs (at step St105). Here, the judgment whether the current control range 1 is changed or not can be made by the emission control unit 22 on the basis of the light intensities, or the judgment can be made by the CPU 12 after the emission control unit 22 transmits the light intensity information to the CPU 12.

In the case where the intensity changing processing for light adjustment operation is selected (N at step St103), after steps St110 to St112 as is the case with FIG. 7, the emission control unit 22 makes the semiconductor laser components 5a to 5c emit lights with light intensities corresponding to plural points within the current control range 2 during the flyback period, makes the photosensor 10 detects the light intensities, and obtains the light intensities via the amplifier 9 (at step St113). It is judged whether the current control range 2 is changed or not on the basis of this obtained light intensities, and if the current control range 2 is changed, an LUT corresponding to the new current control range is selected out of the fixed LUTs (at step St114). Here, the judgment whether the current control range 2 is changed or not can be made by the emission control unit 22 on the basis of the light intensities, or the judgment can be made by the CPU 12 after the emission control unit 22 transmits the light intensity information to the CPU 12. Subsequently, as is the case with FIG. 7, the flow goes back to step St102 after steps St119 and St120.

With the above-described processing, because LUTs corresponding to the current control ranges applied to the light adjustment operation are created in advance, the laser projection/display apparatus can promptly switch the brightness of an image with the number of displayed gradations kept constant. It goes without saying that a change in the white balance of a displayed image owing to the variation in temperature can be reduced in this embodiment as is the case with each of the above-described embodiments.

### Fourth Embodiment

A fourth embodiment has the normal operation processing different from the normal operation processing steps of the above first to third embodiments. To put it concretely, in the fourth embodiment, one of the current control range and the gain of the amplifier 9 in a flyback period is set different from those in a display period. With such a control method, during the normal operation processing, a current control range, within which a laser light is too weak for the photosensor 10 to detect, can be dealt with. In addition, a very weak laser light, which is corresponding to the vicinity of the threshold current, that is, which is in the vicinity of the detection lower limit of the photosensor 10, can be accurately detected.

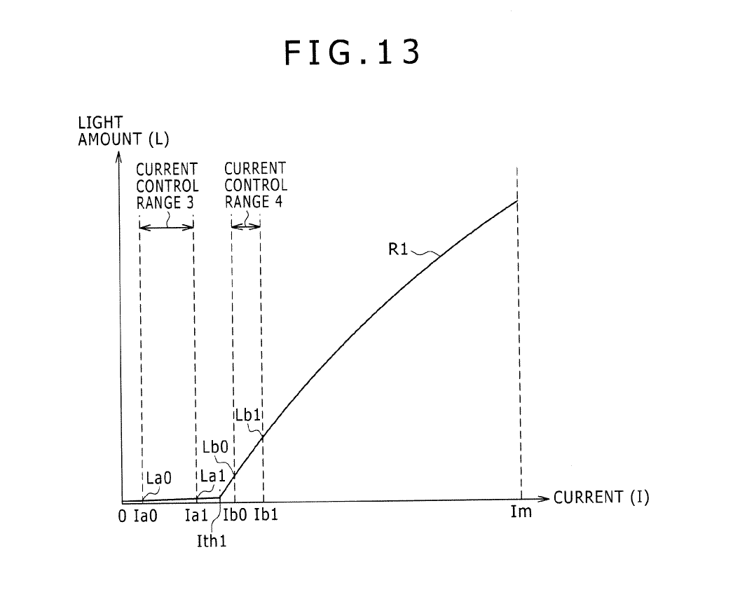

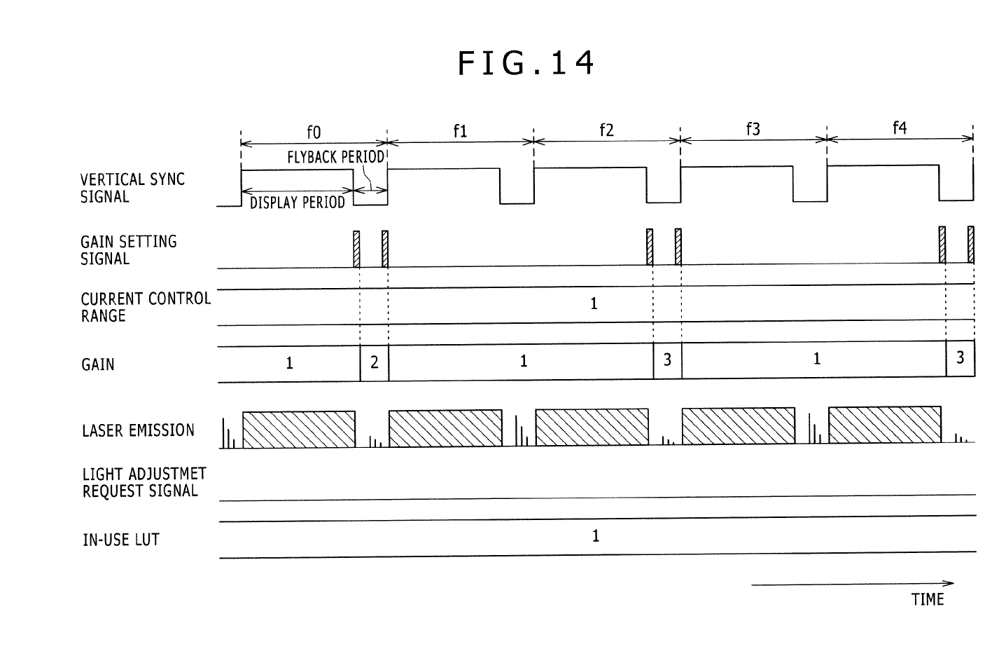

Hereinafter, a configuration in which either one of the current control range and the gain of the amplifier 9 in the flyback period are set different from those in the display period even in the normal operation processing will be explained as the fourth embodiment of the present invention with reference to FIG. 13 and FIG. 14. Here, components having the same configurations and functions as those of components of the first to third embodiments are denoted by the same reference numerals, and detailed explanations thereof will be omitted.

FIG. 13 is a characteristic diagram showing an example of light amount versus forward current characteristic of a semiconductor laser component. As shown in FIG. 13, the semiconductor laser component has a characteristic showing a drastic increase in its light amount with a certain threshold current Ith1 as a boundary value. In addition, the ratio of the variation of the light amount to the variation of the current is not constant, and it has a nonlinear characteristic shown by R1 in FIG. 13. Here, a case is considered where the current control range of a displayed image is set to a current control range 3 that is used for forming a very dark image. It will be assumed that a light amount between a light amount La0 to a light amount La1 within the current control range 3 is a light amount too small for the photosensor 10 to detect.

In the case where a light amount from the light amount La0 to the light amount La1 cannot be detected by the photosensor 10, a current control range and a gain of the amplifier 9, which are different from those for the normal operation period, are set in a flyback period, and a current control range during a display period is changed on the basis of obtained data. In other words, in order to change the current control range 3 so that the temperature characteristic of the light amount is not fluctuating, data is obtained within a current control range 4 where a light amount from a light amount Lb0 to a light amount Lb1 can be detected by the photosensor 10.

Hereinafter, a procedure for changing the current control range 3 using the current control range 4 during the normal operation processing will be explained. When the flyback period begins after the display period is over, the in-use current control range is changed from the current control range 3 during the display period to the current control range 4. After the in-use current control range is changed, the emission control unit 22 transmits image signals that makes currents flowing through a laser light component Ibo and Ib1 respectively to the current gain circuit 24, the light intensities corresponding to these currents are detected by the photosensor 10, the detected light intensities are supplied to the emission control unit 22 via the amplifier 9, and the emission control unit 22 obtains the light intensity signals Lb0 and Lb1. The emission control unit 22 or the CPU 12 calculates the value of the threshold current Ith1 from the obtained Lb0 and Lb1 using collinear approximation. A fixed constant Ic (Ic=Ith1−Ia1) is stored in advance in a not-shown memory area. Every time the value of Ith1 is calculated by the abovementioned method, the value of Ia1 can be determined using the fixed constant Ic. The value of Ia0 can be calculated by subtracting a predefined number from the value of Ia1. With the abovementioned calculation method, the current control range 3, within which a laser light is too weak for the photosensor 10 to detect, can be converted so that the temperature characteristic of the light amount is not fluctuating on the basis of the threshold current Ith1 calculated using the current control range 4 that is different from the current control range 3.

Next, a method, in which a very weak laser light, which is corresponding to the vicinity of the threshold current, that is, which is in the vicinity of the detection lower limit of the photosensor 10, can be accurately detected, will be explained with reference to FIG. 3 and FIG. 14.

As described above, FIG. 3 is a characteristic diagram showing an example of light amount versus forward current characteristic of a semiconductor laser component. As shown in FIG. 3, the semiconductor laser component has a characteristic showing a drastic increase in its light amount with a certain threshold current Ith1 as a boundary value. Here, it is important to accurately detect the value of the threshold current Ith1 for determining the current control range 1. Therefore, for determining the current control range 1, it is preferable to detect a weak light amount Ls using a current I2 which is in the vicinity of the threshold current Ith1 and a light amount corresponding to which is in the vicinity of the detection lower limit of the photosensor 10. However, because the light amount Ls is weak, it is difficult to accurately detect the light amount Ls using the amplifier with the same gain as the gain of the amplifier 9 used for detecting the light amount Lm. Accordingly, it is necessary to make it possible to detect the weak light amount Ls by setting the gain of the amplifier 9 in a flyback period different from that of the amplifier 9 during a display period even during the normal operation processing. In addition, it goes without saying that this method is applicable not only to the fourth embodiment but also to the first to third embodiments.

Next, the concrete timing chart of the normal operation processing will be explained with reference to FIG. 14.

FIG. 14 is a timing chart showing the entire processing of the fourth embodiment, and shows timings regarding a vertical sync signal, a gain setting signal, a current control range, a gain, a laser emission, a light adjustment request signal, and an in-use LUT. Here, it will be assumed that the timing chart shown in FIG. 14 is a timing chart dealing with the same light adjustment operation processing as that of the first embodiment.

In FIG. 14, while the light adjustment operation processing is performed during the flyback period of the frame f0, the normal operation processing is performed during the flyback periods of the frames f1 to f4. The gain of the amplifier 9 is set to the gain 1 during the flyback periods of the frames f1 and f3, while the gain of the amplifier 9 is set to a gain 3 during the flyback periods of the frames f2 and f4. Here, the light adjustment operation processing in the frame f0 and the normal operation processing in the frame 1 are respectively the same as those of the first embodiment.

During the flyback period of the frame f2 after the display period of the frame 2, the emission control unit 22 changes the gain of the amplifier 9, which amplifies the output from the photosensor 10, from the gain 1 corresponding to the current control range 1, which is a current control range during the display period, to the gain 3 for detecting the weak light amount Ls and light amounts in the vicinity of the light amount Ls. Subsequently, a laser light is emitted with a weak light intensity within the current control range 1, the light intensity is detected by the photosensor 10, and the detected light is obtained via the amplifier 9. The light amounts corresponding to currents in the vicinity of the above current I2 can be detected by changing the gain in such a way.

Whether the current control range 1 is changed or not is judged on the basis of the obtained light intensity, and before a display period begins, the emission control unit 22 changes the gain from the gain 3 for detecting the weak light amount Ls and the light amounts in the vicinity of the light amount Ls to the gain 1 corresponding the current control range 1. By changing the gain in accordance with an obtained light amount in such a way, a weak light amount can be accurately detected. This also means that the accuracy of the current control range, and the accuracy of an LUT to be updated are improved.

As described above, according to this embodiment, by setting either one of the current control range and the gain of the amplifier 9 in a flyback period different from its counterpart in a display period, a current control range, within which a laser light is too weak for the photosensor 10 to detect, can be dealt with even in the intensity changing processing for normal operation. In addition, a very weak laser light, which is corresponding to the vicinity of the threshold current, that is, which is in the vicinity of the detection lower limit of the photosensor 10, can be accurately detected.

What is claimed is:

1. A laser projection/display apparatus for displaying an image corresponding to an image signal by projecting laser lights of a plurality of colors corresponding to the image signal, comprising:
a laser light source that emits the laser lights of the colors;
a laser light source drive unit that drives the laser light source so that the laser light source emits laser lights corresponding to the image signal;
a scanning unit that scans the laser lights emitted by the laser light source in accordance with a sync signal related to the image signal;
a photosensor that detects the light amounts of the laser lights emitted by the laser light source; and
an image processing unit that processes the image signal in accordance with the light amounts of the laser lights detected by the photosensor, and supplies the processed image signal to the laser light source drive unit,
wherein the image processing unit obtains data used for making the light amounts of the laser lights, which are detected by the photosensor, equal to respective predefined values regarding a plurality of luminance levels during the flyback period of the image signal, and the image processing unit processes the image signal to be supplied to the laser light source drive unit on the basis of the data when the image signal is projected and displayed.

2. The laser projection/display apparatus according to claim 1,
wherein the image processing unit obtains data used for making the light amounts of the laser lights, which are detected by the photosensor, equal to respective predefined values regarding a plurality of luminance levels at a second luminance that is different from a first luminance, which is the luminance of the image currently being displayed, during the flyback period of the image signal, and the image processing unit processes an image signal to be supplied to the laser light source drive unit on the basis of the data when the image signal is projected and displayed with the second luminance.

3. The laser projection/display apparatus according to claim 2, further comprising an illuminance sensor that detects the brightness of the periphery of the laser projection/display apparatus,
wherein the image processing unit changes the luminance of an image to be displayed from the first luminance to the second luminance in accordance with the brightness detected by the illuminance sensor.

4. The laser projection/display apparatus according to claim 2,
wherein the image processing unit changes the luminance of an image to be displayed from the first luminance to the second luminance in accordance with the instructions of a user of the laser projection/display apparatus.

5. The laser projection/display apparatus according to claim 2,
wherein the image processing unit changes the gains of signals showing the amounts of the laser lights detected by the photosensor, and processes an image signal to be supplied to the laser light source so that the light amounts of the laser lights become equal to respective predefined values.

6. The laser projection/display apparatus according to claim 5,
wherein the gains in the image processing unit during the display period of the image signal are respectively different from the gains during the flyback period of the image signal.

7. The laser projection/display apparatus according to claim 2,
wherein the first luminance is a luminance for displaying an image in the bright state of the periphery, and
the second luminance is a luminance for displaying an image in the dark state of the periphery.

8. The laser projection/display apparatus according to claim 2,
wherein the image processing unit stores data, which is obtained for setting an image signal to be supplied to a laser light source, in an LUT that is a data table when the image processing unit displays an image with the second luminance, and updates the data.

9. The laser projection/display apparatus according to claim 1,
wherein the laser light drive unit current-drives the laser light source; and
the image processing unit obtains the threshold of the current that sets the light amount of a light emitted by the laser light source to the predefined lower limit value, and processes an image signal to be supplied to the laser light source drive unit so that the laser light source is driven with a current whose upper limit value is obtained by subtracting a predefined value from the threshold in the case where the laser light source is driven with a current less than the threshold.
